(19) United States
(12) Patent Application Publication
(10) Pub. No.: US 2026/0250195 A1
(43) Pub. Date: Aug. 27, 2026

(54) A STRUCTURAL COMPOSITE MATERIAL AND COMPOSITIONS AND METHODS FOR THE PRODUCTION THEREOF

(71) Applicant: Sunrise Envirotech Pty Ltd, Figtree (AU)

(72) Inventors: Lee Styger, Albion Park (AU); Michael O'Brien, Figtree (AU)

(73) Assignee: Sunrise Envirotech Pty Ltd, Figtree (AU)

(21) Appl. No.: 19/126,213

(22) PCT Filed: Oct. 25, 2023
(86) PCT No.: PCT/AU2023/051064

§ 371 Date: Apr. 30, 2025

(30) Foreign Application Priority Data
Oct. 31, 2022 (AU) 2022903241
Aug. 22, 2023 (AU) 2023902659

(51) Int. Cl. C04B 18/16; C04B 26/14; C04B 26/16; C04B 26/18; C04B 103/00

(52) U.S. Cl. CPC C04B 18/16; C04B 26/14; C04B 26/16; C04B 26/18; C04B 2103/0062

(57) ABSTRACT

The invention relates to a structural composite material comprising: an active material and a matrix material. In embodiments, the active material comprises limestone, potash, zeolite, inorganic mined materials, bauxite residue (red mud), critical minerals waste, reclaimed demolition materials, industrial and municipal waste or E-waste; and the matrix material comprises epoxy resin, polyester resin, polyurea, a polymer or a material that exhibits interlocking or cross-linking.

### CROSS REFERENCE TO RELATED APPLICATIONS

This is the U.S. National Stage of International Application No. PCT/AU2023/051064, filed Oct. 25, 2023, which was published in English under PCT Article 21(2), which in turn claims the benefit of Australian Patent Application No. 2022903241, filed Oct. 31, 2022, and Australian Patent Application No. 2023902659, filed Aug. 22, 2023. The applications are incorporated herein in their entirety.

### TECHNICAL FIELD

The present invention relates to the field of composite materials and in particular structural composite materials and methods for producing a structural composite material. In embodiments the invention relates to structural composite materials comprising waste materials as constituents or fillers. The invention is particularly suited for use in the remedial maintenance of a substrate, such as an item of infrastructure such as a water or sewer pipe, surface protection of an item of infrastructure, containment of waste, capping of bores, moulding of polymers and filtration of liquids and solids. However, it is to be appreciated that the invention may have broader application.

### BACKGROUND OF THE INVENTION

Embedded infrastructure such as sewer pipes and water pipes are prone to long-term damage due to microbial attack or erosion and corrosion. Existing remedial maintenance processes include directly replacing the system, or physically repairing the corroded internal surface, both of which are costly, or applying a chemical neutraliser coating to the surface of the infrastructure to prevent further microbial attack. The chemical neutraliser requires ongoing application to maintain protection. The coatings often do not bond well which limits their effectiveness and hence offers only a short term solution which and they can also be costly.

There are existing composites that are used for maintenance and remedial purposes of infrastructure such as water or sewer pipes. Existing solutions include laminate, pre-impregnated composites or thermoplastics.

Laminate composites are applied to infrastructure manually or semi-automatically. Laminate composites comprise fibrous reinforcement material such as glass and carbon. The disadvantages of laminate composites include inadequate inter-laminate bonding, resin or glass-rich areas, variable surface coverage, delamination, and liquid ingress. Also, access to the location at which maintenance or remediation is required can be limited which can prevent or limit the use of laminate composites.

Pre-impregnated composites are materials in which a reinforcement fibre such as glass fibre is pre-impregnated with a polymer resin. The disadvantages of pre-impregnated composites include that they are prone to collapse, are relatively difficulty and costly to apply and can tend to partially cure before use which can adversely affect the mechanical properties of the composite. To alleviate some drawbacks, pre-impregnated composites tend to be relatively thin which limits their mechanical strength and ultimately their usefulness.

Thermoplastics tend to be applied as a ‘solid’ where energy is used to change the state of the material to conform to topography being moulded. They are different to composites, do not bond to the infrastructure and typically have to be joined or bonded together using adhesives, solvents and/or mechanical means.

Accordingly, a need exists for a material and/or a method that is useful for maintenance and remedial purposes of infrastructure such as water or sewer pipes that is resistant to the effects of erosion and microbial attack. A need exists for a material and/or a method that is suitable for maintenance and remedial purposes of infrastructure that can be applied on a large scale and economically.

Furthermore, a need exists for a maintenance and/or remedial material that can be applied in situ and possesses bonding and/or adhering properties.

A need exists for a maintenance and/or remedial material that forms a protective and performance enhancing layer on the surface of infrastructure.

A need exists for a maintenance and/or remedial material that does not require additional reinforcement and/or a support structure.

### SUMMARY OF THE INVENTION

In one aspect, the present invention relates to a structural composite material comprising: 80-90% of filler material and 10-20% of matrix material, wherein the matrix material is epoxy, polyester resin or polyurea, wherein the matrix material exhibits interlocking or cross-linking.

In embodiments, the invention relates to a structural composite material comprising between about 5 wt % to 90 wt % of the active material, between about 10 wt % to 95 wt % of the matrix material, and between about 3 wt % to 90 wt % of the reinforcement material to form a mixture. In preferred embodiments, the structural composite material comprises 80 wt % to 90 wt % of the active material; 10 wt % to 20 wt % of the matrix material; and 5 wt % to 10 wt % of the reinforcement material dispersed within the matrix. In a preferred embodiment, the structural composite material comprises about 85 wt % of the active material.

In embodiments, the invention relates to a structural composite material comprising: 10 wt % to 20 wt % of the active material; 80 wt % to 90 wt % of the matrix material; and 5 wt % to 10 wt % of the reinforcement material dispersed within the matrix. In a preferred embodiment, the structural composite material comprises about 85 wt % of the matrix material.

In embodiments, the active material is one of stone such as limestone or road base, potash, or zeolite or in embodiments comprises inorganic mined materials or waste products such as bauxite residue (red mud) or critical minerals waste, reclaimed demolition materials, industrial and municipal waste, E-waste or combinations thereof. In embodiments, the matrix includes one of epoxy resin, polyester resin or polyurea or in embodiments comprises a polymer or a material that exhibits interlocking or cross-linking; or combinations thereof. In embodiments, the structural composite material includes reinforcement fibre comprised of one of glass, carbon, steel, wool, hemp or fibrous plant material or combinations thereof.

Preferably, the active material comprises bauxite residue (red mud) and the matrix material comprises a material that exhibits interlocking or cross-linking.

In embodiments, the structural composite material further includes a reinforcement material comprised of glass, carbon, steel, wool, or hemp or fibrous plant material.

Preferably, the reinforcement material comprises 5 wt % to 10 wt % of the structural composite material.

The structural composite material of any one of the preceding claims, wherein the active material has particles that are multi-faceted, angular, enable interlocking and/or enable close primal placing and vary in size.

In some embodiments, the structural composite material comprises a cure catalyst, preferably including Methylene Diphenyl Isocyanate (MDI) or Toluene Diisocyanate (TDI), wherein the curing rate is 5 to 30 seconds

In a further aspect, the invention relates to a method for making a structural composite material including combining: a filler material comprising limestone, road base, potash, or zeolite or inorganic mined materials, bauxite residue (red mud), critical minerals waste, reclaimed demolition materials, industrial and municipal waste, E-waste or combinations thereof and a matrix material comprising epoxy resin, polyester resin, or polyurea, wherein the matrix material exhibits interlocking or cross-linking, and wherein the filler material comprises 80-90% of the composite and the matrix material comprises 10-20% of the composite.

In embodiments, the method includes combining between about 5 wt % to 90 wt % of active material, between about 10 wt % to 95 wt % of matrix material, preferably about 85 wt % of the matrix material, and between about 3 wt % to 90 wt % of reinforcement fibre to form a mixture; and heating the mixture to a temperature of 5 degrees Celsius to 65 degrees Celsius for 5 to 30 minutes.

Preferably, the method includes combining between 10 wt % to 20 wt % of the active material; 80 wt % to 90 wt % of the matrix material.

In embodiments, the method includes further combining a reinforcement material comprised of glass, carbon, steel, wool, or hemp or fibrous plant material.

Preferably, the reinforcement material comprises 5 wt % to 10 wt % of the structural composite material.

Preferably the method includes heating the mixture to a temperature of 5 degrees Celsius to 65 degrees Celsius for 5 to 30 minutes.

### Neutraliser

In embodiments, the structural composite includes a neutraliser. Preferably the neutraliser is embedded into a homogeneous mixture of the structural composite material wherein the outermost deposit of the coating is designed to degrade at a predictable rate. Preferably the neutraliser is magnesium hydroxide. In embodiments, the neutraliser includes a quaternary ammonium salt, aliphatic amine fatty acid condensate, methyl propargyl alcohol, potassium bromide or potassium iodide.

Accordingly, in embodiments, the structural composite includes a mixture of magnesium hydroxide and any one or more of: limestone, potash and zeolite.

In embodiments, the structural composite including the neutraliser is provided on the surface of a substrate, such as an item of infrastructure (e.g. a pipe) to form a protective layer thereon. Preferably, the protective layer on the surface of the substrate is adapted to degrade with exposure to certain conditions, and preferably in a predictable way, whereby spent neutraliser is removed from the structural material to expose fresh neutraliser in the structural composite material.

### Multi-Material Hybrid Composite

In embodiments, the structural composite material is deposited onto a substrate.

In embodiments, the method includes providing multiple feeds of mixtures of the structural composite material and delivering them to a blending chamber prior to deposition onto a substrate. Preferably the mixtures include gypsum or Ordinary Portland Cement (OPC).

Preferably, the mixtures of the structural composite material are continuously deposited onto a substrate. However, the product can achieve mechanical strength or molecular bonding post-curing phase.

### Waste Containment and Management

In embodiments, the method includes forming a containment vessel from the structural composite material mixture including providing an existing container into a mould or a form and filling a space around the container with the structural composite material.

### Plug and Abandonment of Wells

In embodiments, the method includes providing the mixture of the structural composite material into a wellbore and curing the mixture to form a plug in the wellbore.

### Moulding of Geopolymers

In embodiments, the structural composite material forms, at least in part, a mould for forming a geopolymer material.

Preferably, the mould includes a mould cavity defined between a substrate and a porous mould membrane comprised of the structural composite material.

### Renewable Storage & Infrastructure

In embodiments, the structural composite material is used for the storage and transportation of gases such as syngas, hydrogen etc. under pressure, and is able to prevent corrosion and hence leakage present in current infrastructure associated with these renewable energy technologies.

### Filtration and Remediation of Fluids and Solids

In embodiments, the structural composite material comprises a syntactic foam.

Preferably, the foam is rigid or flexible.

In embodiments, the foam contains an active material, such as zeolite, wherein the foam is adapted to filter, hold, capture or exchange ions or compounds such as carbon dioxide or hydrogen gas.

In embodiments, the syntactic foam material is adapted for filtering fluid.

### Apparatus and System for Treatment of Water

In yet another embodiment, the syntactic foam material is incorporated in a filtration apparatus or the syntactic foam material forms the filtration apparatus.

Preferably, the filtration apparatus is adapted for filtering fluid.

### BRIEF DESCRIPTION OF THE FIGURES

The present invention will now be described in more detail with reference to preferred embodiments illustrated in the accompanying figures, wherein:

FIG. 1 is a flowchart illustrating a method of making a structural composite material in accordance with an embodiment of the invention including combining a mixture of an active material and a matrix material;

FIG. 2 is a flowchart illustrating a method of making a structural composite material in accordance with another embodiment of the invention including combining a mixture of an active material, a matrix material and a reinforcement material;

FIG. 3 illustrates a cross-sectional view of an item of infrastructure, namely a pipe, including a layer of structural composite material in accordance with an embodiment of the invention provided on a surface thereof;

FIG. 4 illustrates a cross-sectional view of a substrate including a layer of structural composite material including a neutraliser in accordance with an embodiment of the invention provided on a surface thereof;

FIG. 5 illustrates a method for forming a containment vessel from a structural composite material in accordance with an embodiment of the invention;

FIG. 6 illustrates a method and apparatus for forming a containment vessel from a structural composite material in accordance with an embodiment of the invention;

FIG. 7 illustrates a method for forming a seal or a cap on an unused oil or gas wellbore using a structural composite material in accordance with an embodiment of the invention;

FIG. 8 illustrates a method of moulding or forming a geopolymer material using a structural composite material in accordance with an embodiment of the invention to form, at least in part, a mould or form; and

FIG. 9 illustrates a syntactic foam material adapted for filtering fluid in accordance with an embodiment of the invention.

### DETAILED DESCRIPTION

The present invention relates to a structural composite material and methods to manufacture a structural composite material. The structural composite material described herein is suitable for structural applications including the remedial maintenance of infrastructure, surface protection of infrastructure, containment of waste, capping of bores, moulding of polymers and filtration of liquids and solids.

In one aspect, the present invention relates to a structural composite material. The structural composite material is homogenous, comprising an active material, a matrix material and a reinforcement material. The homogenous structural composite material is advantageous as it promotes structural integrity and longevity. In embodiments, deposits of the structural composite material are homogenously blended, alleviating bonding weaknesses between deposits of similar and dissimilar materials. In another aspect, the present invention relates to a structural composite material that is multi-layered, comprising an active material layer, a matrix material and a reinforcement material, wherein the components or mixtures thereof are arranged in layers.

In embodiments, the active material comprises an active filler/additive including zeolite, limestone, potash, inorganic mined materials bauxite residue (red mud), critical minerals waste, industrial and municipal waste, E-waste or reclaimed demolition materials that may contain the aforementioned materials or combinations thereof. In embodiments, an active material is provided in an outer layer of the structural composite material. The active layer is advantageous as the active filler/additive allows for continuous cation exchange. In embodiments, the active layer is designed to expose new active filler as it degrades over time, thus maintaining cation exchange.

Preferably, the matrix comprises epoxy, polyurea, polyester-vinyl or a polymer or a material that exhibits interlocking or cross-linking. Preferably, the reinforcement fibre comprises at least one fibre selected from glass, carbon, steel, wool, hemp or fibrous plant material or a combination thereof.

In embodiments, the structural composite material possesses a rapid curing rate of 3 to 30 or 5 to 30 seconds. An advantage of the rapid curing rate is the ability to directly manufacture on site.

In a further aspect, the invention relates to a method for manufacturing a structural composite material. The method involves combining 80 wt % to 90 wt % of the active material and 10 wt % to 20 wt % of the matrix material or 10 wt % to 20 wt % of the active material, 80 wt % to 90 wt % of the matrix material (or increments therebetween), and 5 wt % to 10 wt % of reinforcement fibre to form a mixture. The mixture is heated to a temperature of 60° C. to 85° C. for 5 to 30 minutes. In another embodiment, the method involves combining a mixture comprising about 85 wt % of the active material which is heated to a temperature of 60° C. to 85° C. for 5 to 30 minutes. In embodiments, the cure cycle is catalysed by isocyanates including either methylene diphenyl-4,4′-diisocyanate (MDI) or TDI. The rapid curing rate of the structural composite material allows for direct manufacturing on site, therefore reducing environmental impact and improving logistics such as time and costs.

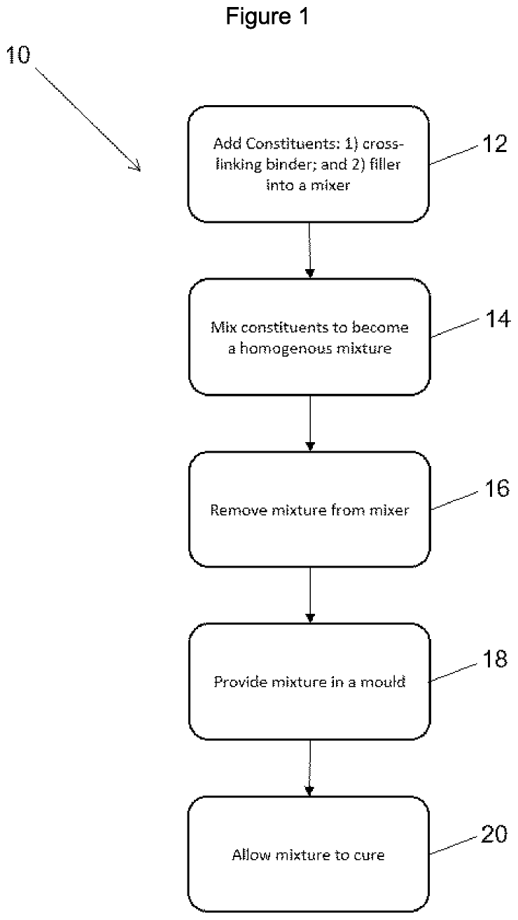

FIG. 1 is a flowchart illustrating an embodiment of the method 10 of making a structural composite material. The method 10 includes a step of adding constituents into a mixer 12, namely the active material and the matrix material. The constituents are then mixed to provide a homogonous mixture 14. The mixture is removed from the mixer 16 and then applied to a substrate 18, such as a pipe or some other piece of infrastructure. Alternatively, the mixture is placed into a mould or a form. The mixture is then allowed to cure 20 to thereby form the final structural composite material.

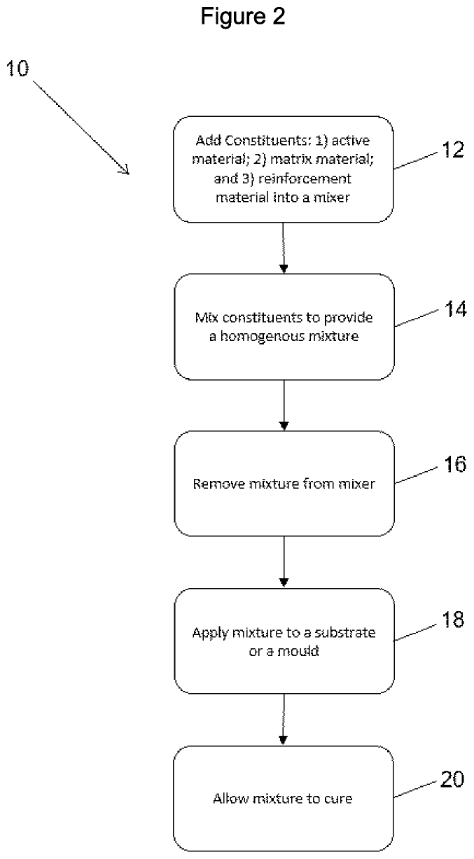

FIG. 2 is a flowchart illustrating another embodiment of the method 30 of making a structural composite material. The method 30 includes a step of adding constituents into a mixer 32, namely the active material, the matrix material and the reinforcement material. The constituents are then mixed to provide a homogonous mixture 34. The mixture is removed from the mixer 36 and then applied to a substrate 38, such as a pipe or some other piece of infrastructure. Alternatively, the mixture is placed into a mould or a form. The mixture is then allowed to cure 40 to thereby form the final structural composite material.

### Composition

The present invention includes a structural composite material comprising: an active material comprising zeolite, limestone, potash, inorganic mined materials or reclaimed demolition materials or a combination thereof; a matrix material comprising epoxy resin, polyester resin, polyurea or a polymer or a combination thereof; and a reinforcement material such as glass, carbon, steel, wool, hemp or fibrous plant material.

In embodiments, the invention relates to a structural composite material comprising: 80 wt % to 90 wt % or preferably about 85 wt % of the active material; 10 wt % to 20 wt % of the matrix material; and 5 wt % to 10 wt % of the reinforcement material dispersed within the matrix.

In embodiments, the active material is limestone, potash, zeolite, inorganic mined materials, bauxite residue (red mud), critical minerals waste, industrial waste, municipal waste, E-waste or demolition materials; the matrix material is epoxy resin, polyurea, a polymer or polyester resin or a material that exhibits interlocking or cross-linking; and the reinforcement material is a fibre, glass, carbon, steel, wool, hemp or fibrous plant material. In some embodiments, the structural composite material comprises a cure catalyst, preferably including MDI or TDI, wherein the curing rate is 5 to 30 seconds.

Suitably, the composite material comprises a mixture of more than one of the active materials (i.e. a mixture of the limestone, potash, zeolite, inorganic mined materials, bauxite residue (red mud), critical minerals waste, industrial waste, municipal waste, E-waste or demolition materials). Suitably, the composite material comprises a mixture of more than one of the matrix materials (i.e. a mixture of the epoxy resin and/or polyester resin and/or polyurea and/or a polymer or a material that exhibits interlocking or cross-linking). Suitably, the composite material comprises a mixture of more than one of the reinforcement materials (i.e. a mixture of the fibre, glass, carbon, steel, wool, hemp or a fibrous plant material).

In embodiments, the composite material may be porous. In embodiments, the composite material comprises a syntactic foam material.

In embodiments, the composite material suitably has a density in the range of 1.5 g/cm³ to 2.5 g/cm³.

### Remedial Maintenance and Protection of Infrastructure

Embedded infrastructure such as sewer pipes and water pipes are prone to long-term damage due to microbial attack or erosion and corrosion.

Existing remedial maintenance processes include directly replacing the system which is costly or applying a chemical neutraliser coating to the surface of the infrastructure to prevent further microbial attack. The chemical neutraliser requires ongoing application to maintain protection. The coatings often do not bond well and are costly.

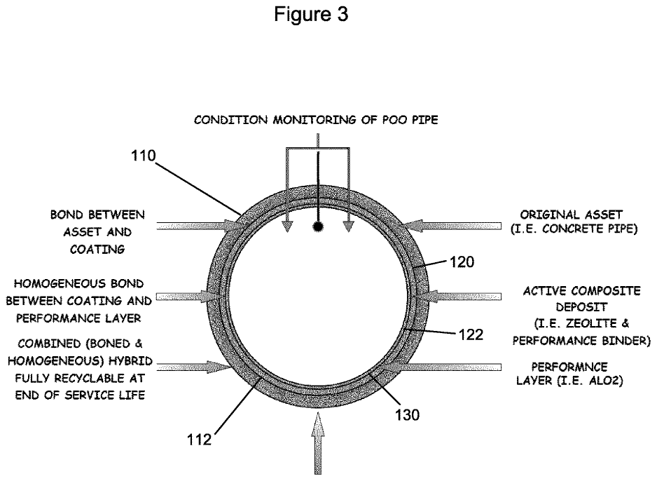

FIG. 3 illustrates a cross-sectional view of an item of infrastructure, namely a pipe 110, including a layer of structural composite material 120 in accordance with an embodiment of the invention provided on a surface thereof. The structural composite material 120 is provided on an inner surface 112 of the pipe 110. An optional performance layer 130 is provided on an inner surface 122 of the structural composite layer 120.

### Neutraliser

In embodiments, the structural composite includes a neutraliser. Preferably the neutralizer is embedded into a homogeneous mixture of the structural composite material wherein the outermost deposit of the coating is designed to degrade at a predictable rate. Preferably the neutraliser is magnesium hydroxide. In other embodiments, the neutraliser includes a quaternary ammonium salt, aliphatic amine fatty acid condensate, methyl propargyl alcohol, potassium bromide or potassium iodide.

Accordingly, in embodiments, the structural composite includes a mixture of a neutraliser (for example magnesium hydroxide) and any one or more of: limestone, potash, zeolite bauxite residue (red mud), critical minerals waste, industrial waste, municipal waste or E-waste.

In embodiments, the structural composite including the neutraliser is provided on the surface of a substrate, such as an item of infrastructure (e.g. a pipe) to form a protective layer thereon. Preferably, the protective layer on the surface of the substrate is adapted to degrade with exposure to certain conditions, and preferably in a predictable way, whereby spent neutraliser is removed from the structural material to expose fresh neutraliser in the structural composite material.

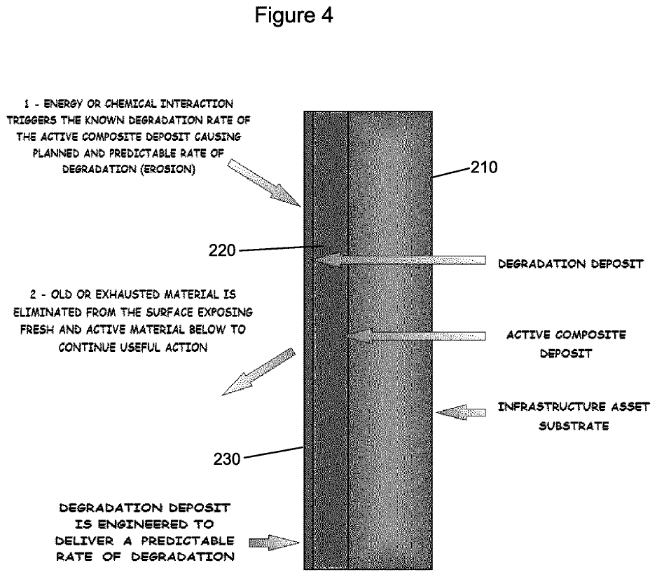

Referring to FIG. 4, there is shown a cross-sectional view of a substrate 210 including a layer of the structural composite material 220 including a neutraliser, such as magnesium hydroxide, provided on a surface thereof. The structural composite includes a homogeneous mixture of an active material, a matrix material and a reinforcement material and the neutraliser. The structural composite material on the surface of the substrate forms a protective and performance enhancing layer that is operable to degrade under certain conditions and in a predictable manner. Spent active neutraliser 230 on an outer layer thereof is removed from the structural material to expose fresh neutraliser in the structural composite material.

In an embodiment, the structural composite includes a visual indicator that provides an indication of when the structural composite, including neutraliser, has degraded to a point at which there is no neutraliser remaining in the structural composite.

### Multi-Material Hybrid Composite

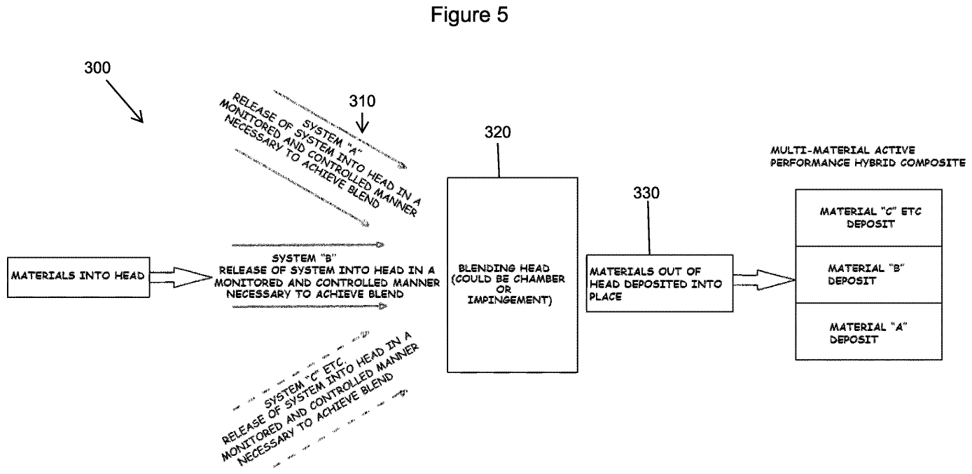

Referring to FIG. 5, there is shown an embodiment of a method 300 and apparatus for the deposition of the structural composite onto a substrate. The method includes providing multiple feeds 310 of structural composite material and delivering them to a blending chamber 320 prior to deposition onto the substrate 330. The multiple feeds of structural composite material includes, for example, a homogeneous mixture of an active material, a matrix material and a reinforcement material. In another example, the structural composite material includes, an epoxy-based composite with a mineral filler such as zeolite, or limestone or fibrous filler such as glass, hemp or carbon, with gypsum or with Ordinary Portland Cement.

The apparatus and method enables the continuous deposition of a plurality of homogeneous composite mixtures, each mixture originating from a respective feed. The plurality of composite mixtures are delivered simultaneously at a single deposition point, for example onto a substrate. Preferably the relative amounts and masses of the composites can be controlled, such as by controlling the rate at which the different composite mixtures are fed and deposited.

### Waste Containment and Management

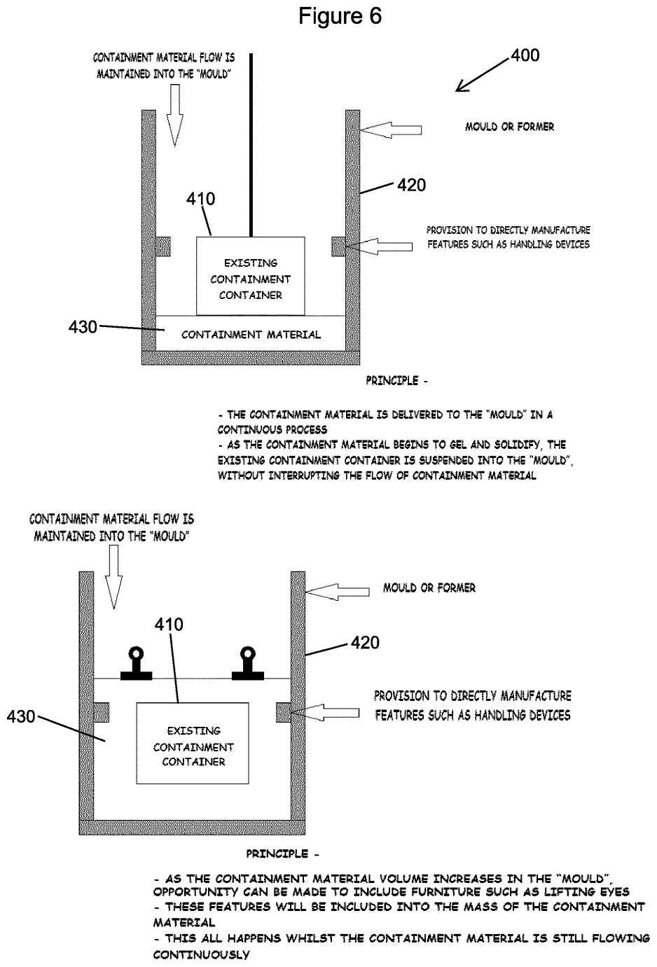

Referring to FIG. 6, there is shown an embodiment of a method 400 for forming a containment vessel from the structural composite material including a homogeneous mixture of an active material, a matrix material and a reinforcement material. FIG. 6 illustrates a step of providing an existing container 410 into a mould or a form 420 and filling a space 430 around the container with the structural composite material 440.

The structural composite material preferably includes a binder such as: epoxy, polyurea, polyester including polyester-vinyl or a polymer and an active material particulate such as: zeolite, limestone, potash inorganic mined materials or reclaimed demolition materials, and a filler such as: glass, carbon, steel, wool or hemp or fibrous plant materials. The composition comprises a protective layer around the container that prevents leaks.

The containment vessel is adapted for containing hazardous materials such as toxic and low-level radioactive wastes, bauxite residue (red mud), critical minerals waste, industrial waste, municipal waste or E-waste. The containment vessel is adapted as an alternative to existing waste containment systems that often comprise cements that are prone to degradation and cracking over time from the waste.

### Plug and Abandonment of Wells

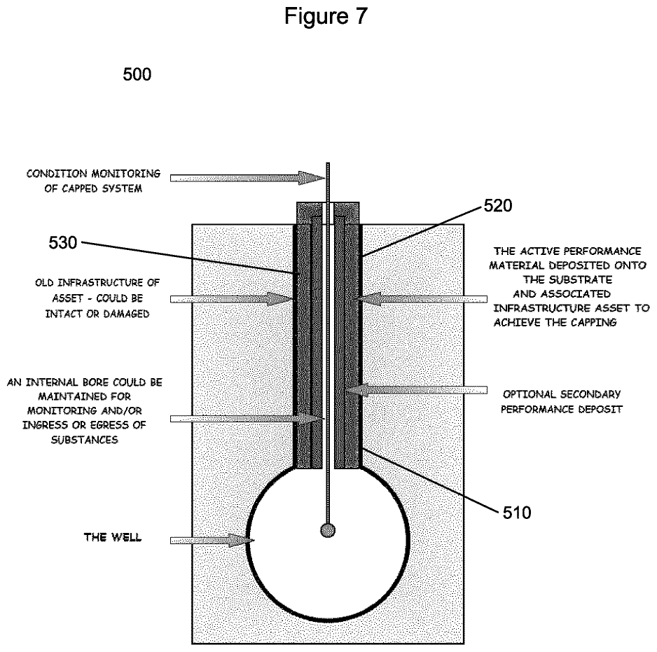

Referring to FIG. 7, there is shown an embodiment of a method 500 for forming a seal or a cap on an unused oil or gas well 510. The method includes mixing a structural composite material in accordance with an embodiment of the invention that preferably includes a binder such as: epoxy, polyurea, polyester including polyester-vinyl and an active material particulate such as: zeolite, limestone, potash, inorganic mined materials or reclaimed demolition materials and a reinforcement fibre such as: glass, carbon, steel, wool, hemp or fibrous plant material. The mixture is provided to the desired location within the wellbore 520 where it cures to create a solid material 530 that takes the shape of the bore, and therefore locks into that shape, thus providing a rigid mechanical connection to the wellbore.

Embodiments of the invention are adapted for plugging unused or abandoned oil and gas wells instead of the traditional method of plugging by concrete plugs to prevent leaks of methane emissions and oil/gas leaks into freshwater aquifers. Existing concrete plugs are prone to microbial attacks, degradation, and corrosion unlike the structural composite material of the invention.

### Moulding of Geopolymers

Geopolymers consist of aluminosilicate-based waste materials including fly ash, ground granulated blast-furnace slag, fumed silica and metakaolin, which are activated using a highly alkaline solution. Throughout production, geopolymers are prone to cracking, shrinking and distortion due to evaporation.

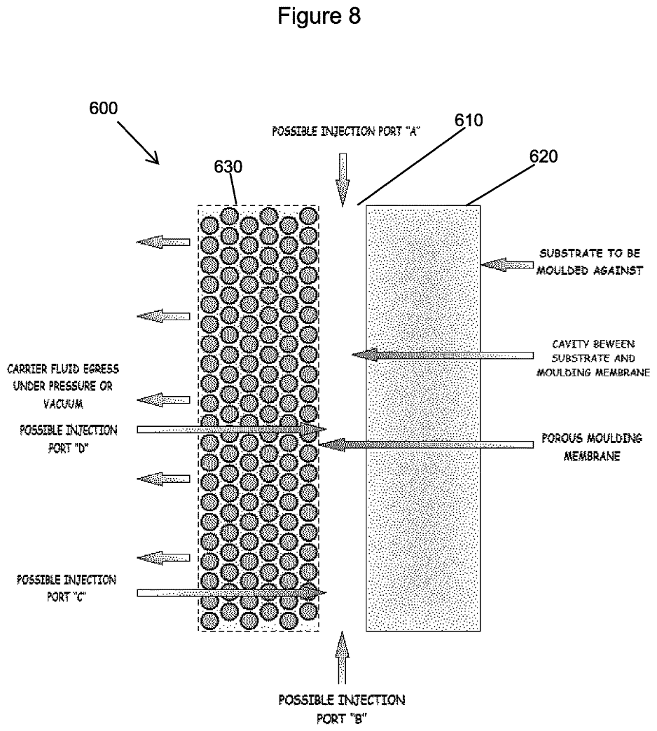

Referring to FIG. 8, there is shown an embodiment of the invention including a mould or a form 600 for moulding or forming a geopolymer material and a method for moulding or forming a geopolymer material. The mould 600 includes a mould cavity 610 defined between a substrate 620 and a porous mould wall 630. The cavity 610 being adapted to receive a geopolymer mixture therewithin.

The method includes forming the mould wall out of a structural porous composite material. The method includes mixing a structural porous composite material including a binder such as: epoxy, polyurea, polyester including polyester-vinyl or a polymer or a material that exhibits interlocking or cross-linking and an active material particulate such as: zeolite, limestone, potash, inorganic mined materials, bauxite residue (red mud), critical minerals waste, industrial waste, municipal waste, E-waste or reclaimed demolition materials, and a reinforcement fibre such as: glass, carbon, steel, wool, hemp or fibrous plant material.

The mixture is formed into a desired shape or configuration by being deposited into a mould or a form. The mixture cures to form a porous mould wall in a desired shape to be used to form at least part of another mould. The resulting porous mould wall is adapted to contact a geopolymer mixture and enables undesirable excess fluid to be drawn out of the geopolymer mixture leaving desirable solids behind. The method is adapted for improving the integrity of the geopolymer during the polymerisation (curing) phase.

Alternatively, the porous mould wall can be used to form the surface of a mould or a tool that is being used to form the geopolymer into a particular shape or configuration.

### Filtration and Remediation of Fluids and Solids

Existing filtration and remediation systems are prone to long-term damage due to microbial attack or erosion and corrosion.

Accordingly, in another embodiment, the invention includes a method for forming a syntactic foam material. The method includes mixing a structural porous composite material including a binder such as: epoxy, polyurea, polyester including polyester-vinyl or a polymer or a material that exhibits interlocking or cross-linking and an active material particulate such as: zeolite, limestone, potash, inorganic mined materials, bauxite residue (red mud), critical minerals waste, industrial waste, municipal waste, E-waste or reclaimed demolition materials, and a filler such as: glass, carbon, steel, wool, hemp or fibrous plant material. Active materials and/or fillers may include demolition materials that may contain some or all of these aforementioned materials.

The foam can be formulated as a rigid, elastomeric or “rubber” type compound enabling other performance capabilities, such as shock absorbing, impact resisting or flexible manoeuvrability. The foam contains an active material such as zeolite, where the properties of the filler are known to have active properties such as cation exchange. The foam can therefore be used to, filter, hold, capture or exchange ions or compounds such as carbon dioxide or hydrogen gas.

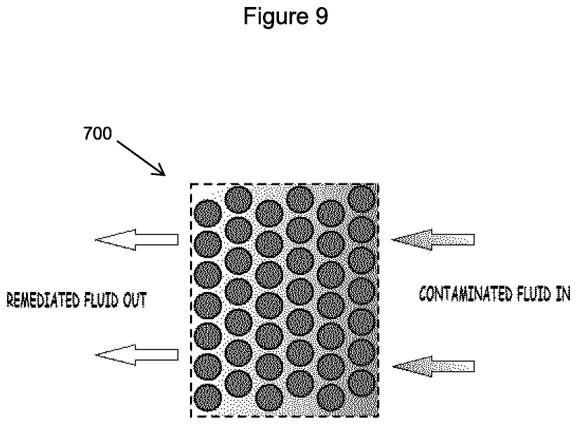

As illustrated in FIG. 9, there is shown an embodiment of the syntactic foam material 700 adapted for filtering fluid. Contaminated fluid enters the syntactic foam from one side and the filtered or remediated fluid exists the syntactic foam on another side.

### Apparatus and System for Treatment of Fluid

In embodiments, the syntactic foam material is incorporated in a filtration apparatus. The filtration apparatus is adapted for filtering fluid. The syntactic foam material is a mixture of a binder such as: epoxy, polyurea, polyester including polyester-vinyl or a polymer or a material that exhibits interlocking or cross-linking and an active material particulate such as: zeolite, limestone or potash inorganic mined materials, bauxite residue (red mud), critical minerals waste, industrial waste, municipal waste, E-waste or reclaimed demolition materials, and a reinforcement fibre such as: glass, carbon, steel, wool, hemp or fibrous plant material.

In yet another embodiment, a water treatment system is provided that can draw in water from a single source such as a water main or bore hole, and/or it can draw in water from a plurality of sources simultaneously, including mains, bores, tanks, gutters, creeks and ponds, its own outputs. Once drawn into the system, water is automatically monitored to assess its condition (e.g. level of purity). Based on the assessed condition of the water it is automatically diverted into one of a plurality of filtration apparatus configured to filter and condition the water.

Weight percentages (wt %) of a particular component are given with reference to any material of which the particular component forms a constituent part. Unless stated otherwise, weight percentages refer to “dry weights”, and suitably exclude any solvents (e.g. water) used to slurry ingredients to assist in the mixing thereof. It will be understood by those skilled in the art that the summation of wt % values for all components with a material (including both stipulated and unstipulated components) should total 100 wt %. It will be understood by those skilled in the art that stipulation of a weight percentage for a particular component does not necessarily limit the potential weight percentage values allowed for other components (whether such other components are stipulated or not), except where a stipulated minimum wt % for the particular component will naturally limit the maximum wt % for other components (whether stipulated or otherwise) given that the total wt % values for all components (including any unstipulated ingredients) will inevitably total 100 wt %.

Particle size relates to the length of the longest dimension of a given particle. Particle size may be measured by a variety of methods well known in the art, including sieving, laser diffraction, and so forth.

1. A structural composite material comprising:
80-90% of a filler material; and
10-20% of a matrix material wherein the matrix material is epoxy, polyester resin or polyurea, wherein the matrix material exhibits interlocking or cross-linking.

2. The structural composite material of claim 1, wherein the filler material comprises limestone, potash, zeolite, inorganic mined materials, bauxite residue (red mud), minerals waste, demolition materials, industrial and municipal waste or E-waste.

3. The structural composite material of claim 1, wherein the filler material comprises bauxite residue (red mud).

4. The structural composite material of claim 1, wherein the matrix material is polyurea.

5. The structural composite material of claim 1, including about 85 wt % of the filler material.

6. The structural composite material of claim 1, further including a reinforcement material comprised of glass, carbon, steel, wool, or hemp or fibrous plant material.

7. The structural composite material of claim 6, wherein the reinforcement material comprises 5 wt % to 10 wt % of the structural composite material.

8. The structural composite material of claim 1, wherein the structural composite material comprises a cure catalyst, preferably Methylene Diphenyl Isocyanate (MDI) or Toluene Diisocyanate (TDI).

9. The structural composite material of claim 1, wherein the curing rate is between 3 seconds and 30 seconds or between 5 seconds and 30 seconds.

10. A method for making a structural composite material including combining: an filler material comprising limestone, potash, zeolite, inorganic mined materials, bauxite residue (red mud), minerals waste, demolition materials, industrial or municipal waste or E-waste and a matrix material comprising epoxy resin, polyester resin or polyurea, wherein the matrix material exhibits interlocking or cross-linking, and wherein the filler material comprises 80-90% of the composite and the matrix material comprises 10-20% of the composite.

11. The method of claim 10, wherein the filler material comprises bauxite residue (red mud).

12. The method of claim 11, including combining: 80 wt % to 90 wt of filler, 10 wt % to 20 wt % of matrix material, and 5 wt % to 10 wt % of reinforcement fibre to form a mixture; and heating the mixture to a temperature of 60 degrees Celsius to 85 degrees Celsius for 5 to 30 minutes.

13. The method of claim 10, including about 85 wt % of the filler material.

14. The method of claim 10, wherein the curing rate is between 3 seconds and 30 seconds or between 5 seconds and 30 seconds.

15. The method of claim 10, further including a reinforcement material comprised of glass, carbon, steel, wool, or hemp or fibrous plant material.

16. The method of claim 15, wherein the reinforcement material comprises 5 wt % to 10 wt % of the structural composite material.
